(19) United States
(12) Patent Application Publication
(10) Pub. No.: US 2017/0129786 A1
(43) Pub. Date: May 11, 2017

(54) MATERIALS, APPARATUSES, AND METHODS FOR SEPARATING IMMISCIBLE LIQUIDS

(71) Applicant: Purdue Research Foundation, West Lafayette, IN (US)

(72) Inventors: Xuemei Chen, West Lafayette, IN (US); Justin A. Weibel, West Lafayette, IN (US); Suresh V. Garimella, West Lafayette, IN (US)

(21) Appl. No.: 15/151,037

(22) Filed: May 10, 2016

Related U.S. Application Data
(60) Provisional application No. 62/253,020, filed on Nov. 9, 2015.

(51) Int. Cl. C02F 1/28; C02F 1/00; B01J 20/32; B01J 20/26; B01J 20/28

(52) U.S. Cl. CPC C02F 1/288; B01J 20/262; B01J 20/28045; B01J 20/3272; C02F 1/285; C02F 1/008; C02F 2101/32

(57) ABSTRACT

Materials, apparatuses, and methods that are suitable for separating immiscible liquids and make use of a porous host material functionalized with a functionalizing agent such that the host material is superhydrophobic.

### CROSS REFERENCE TO RELATED APPLICATIONS

This application claims the benefit of U.S. Provisional Application No. 62/253,020, filed Nov. 9, 2015, the contents of which are incorporated herein by reference.

### BACKGROUND OF THE INVENTION

The present invention generally relates to methods, apparatuses, and systems for separating immiscible liquids, including but not limited to oil and water. The invention particularly relates to separating one or more pollutants from bodies of water, preferably in a continuous process.

The development of absorbent materials with high selectivity for oils and organic solvents is of great ecological importance for removing pollutants from contaminated water sources. Oil spillage and organic-chemicals discharged from industrial sources have caused severe ecological and environmental damage. The conventional methods used to clean oils and organic pollutants include mechanical extraction by oil skimmers, chemical dispersion, and in-situ burning. These methods are slow, energy-intensive, or can cause secondary pollution. In recent years, the use of porous materials with combined superhydrophobic and superoleophilic wetting properties have come to be recognized as one of the more effective approaches for removing oils from water surfaces without such drawbacks.

As used herein, the wetting of a liquid with a surface of a solid material will be described in relation to a contact angle at which the liquid-vapor interface meets the solid-liquid interface. A wettable surface (for example, hydrophilic or oleophilic) is any surface with a contact angle of less than 90° (low contact angle) which indicates that wetting of the surface is very favorable, and a liquid will likely spread over the surface. A nonwettable surface (for example, hydrophobic or oleophobic) is any surface with a contact angle of greater than 90° (high contact angle) which indicates that wetting of the surface is unfavorable, so a liquid will likely minimize contact with the surface and form a compact liquid droplet on the surface. Superhydrophobic and superoleophobic surfaces are surfaces having contact angles greater than 150°, in which case there is likely to be almost no contact between the surface and a liquid drop on the surface. Similarly, superhydrophilic and superoleophilic surfaces are textured surfaces having contact angles of about 10° or less, in which case a liquid is likely to spread over a relatively large area of the surface.

Superhydrophobic/superoleophilic-functionalized filtration materials, such as meshes, membranes, fabrics, and filter paper, have attracted attention over the last decade due to their ability to directly separate oils from water. However, to use this type of material to remove oil from water, the polluted water must be collected and then filtered, which is impractical for application to large bodies of water. Absorbent materials can separate oils from water by manual uptake by absorption and subsequent wringing, or for large-scale cleanup, the oil can be captured continuously via absorption and simultaneously pumped out of the material. An ideal absorbent material should have high absorption capacity and excellent recyclability. Studies on continuous in-situ separation techniques have focused on the development of exotic three-dimensional functional porous materials, including carbon aerogels, carbon-nanofiber aerogels, graphene frameworks or aerogels, and carbon nanotube (CNT) sponges. The complicated preparation processes, high costs, and challenges to scalability inherent in these approaches severely limit their practicality.

Over the last few years, commercially available polymer sponges, such as polyurethane and melamine sponges, have received attention for their potential as oil-absorbent materials because of their open-celled structure, high porosity, and favorable elasticity. While such polymer sponges are naturally wetting, they have been functionalized to be rendered superhydrophobic and/or superoleophilic by modification with nano-structured materials (such as CNTs, graphene, SiO₂, or Fe₃O₄), chemical etching, or polymer grafting, to improve oil selectivity and/or oil-absorbent capacity. However, these functionalized sponges need the introduction of an additional adhesion medium (polydimethylsiloxane (PDMS) or polydopamine) to bind the nano-structured materials onto the sponge skeletons, or require the use strong and corrosive etchants (such as chromic acid), or have limited absorption recyclability. Despite the progress in enhancing the capabilities of superhydrophobic/superoleophilic sponges, cleanup of large-scale water contamination still suffers from a lack of processes for facile fabrication of robust and scalable absorption materials.

Pham et al., “Superhydrophobic silanized melamine sponges as high efficiency oil absorbent materials,” ACS Appl. Mater. Interfaces 2014, 6, 14181-14188, discloses silanization of melamine sponges via a solution-immersion process. The silanization was achieved through reacting secondary amine groups on the surface of the sponge skeletons with alkylsilane compounds, forming self-assembled monolayers on the surface of sponge skeletons. However, this process uses octadecyltrichlorosilane for reaction with the sponges which is a relatively expensive material.

In view of the above, there is an ongoing desire for oil-water separation methods and associated apparatuses and materials that are cost-effective, recyclable, preferably capable of continuous operation, and do not call for environmentally unfriendly chemical agents either in manufacturing the apparatuses and systems or in the final deployment.

### BRIEF DESCRIPTION OF THE INVENTION

The present invention provides materials, apparatuses, and methods suitable for separating immiscible liquids, such as but not limited to oil and water.

According to one aspect of the invention, a material includes a porous host material capable of absorbing a liquid pollutant from water in which the pollutant is immiscible. The host material comprises a polymer coating that defines a functionalized surface that renders the host material superhydrophobic.

According to another aspect of the invention, an apparatus for removing a liquid pollutant from a body of water in which the pollutant is immiscible includes at least one functionalized host material comprising a host material capable of absorbing the pollutant, and a polymer coating on the host material that defines a functionalized surface thereon that is superhydrophobic. The apparatus further includes one or more connecting tubes configured to remove the absorbed pollutant from the at least one functionalized host material and transfer the pollutant to a pollutant container functionally connected to a vacuum pump.

According to another aspect of the invention, a method of removing a liquid pollutant from a body of water in which the pollutant is immiscible includes bringing a functionalized host material to be in contact with a pollutant-water combination. The functionalized host material is superhydrophobic and superoleophilic and therefore selectively absorbs the pollutant while repelling the water. The functionalized host material includes a polymer coating thereon that defines a functionalized surface that is superhydrophobic.

Technical effects of methods, apparatuses, and materials as described above preferably include the capability of separating immiscible liquids, such as but not limited to oil and water, in a continuous operation without requiring the use of environmentally unfriendly chemical agents.

Other aspects and advantages of this invention will be better appreciated from the following detailed description.

### BRIEF DESCRIPTION OF THE DRAWINGS

FIG. 1A and FIG. 1B show scanning electron microscope (SEM) images of melamine sponges with densities of 8 and 9.6 mg/cm³, respectively.

FIGS. 1C through FIG. 1F show SEM images of polyether sponges with densities of 14, 19, 23, and 26 mg/cm³, respectively.

FIG. 2 shows x-ray photoelectron spectroscopy (XPS) spectra of a melamine sponge having a density of 8 mg/cm³ before and after being functionalized with a PDMS coating, as well as the PDMS-coated sponge after 200 compression cycles.

FIGS. 3A through FIG. 3F show images of water and oil droplets placed on functionalized test sponges M8, M9.6, P14, P19, P23, and P26, respectively. In this notation, M indicates that the test sponge was formed of melamine, P indicates that the test sponge was formed of polyether, and the number following the M or P indicates the density of the test sponge in mg/cm³.

FIG. 3G indicates water contact angles for functionalized test sponges with various densities (M8, M9.6, P14, P19, P23, and P26).

FIG. 3H shows images of melamine sponges having densities of 8 and 9.6 mg/cm³ (left and right, respectively) submerged in water.

FIG. 4A is schematic representation of a sponge sample supporting a column of water in an apparatus that measured intrusion pressures of functionalized sponges.

FIG. 4B is a graph representing intrusion pressures for functionalized test sponges with various densities (M8, M9.6, P14, P19, P23, and P26) as measured with an apparatus of the type represented in FIG. 4A.

FIG. 5A is a graph representing absorption capacities of functionalized sponges with various densities (M8, M9.6, P14, P19, P23, and P26) for various oils, namely, hexane, toluene, octadecene, silicone oil, and motor oil.

FIG. 5B is a graph representing absorption recyclability of a functionalized melamine sponge with a density of 8 mg/cm³ (M8).

FIG. 6 represents steps (a through f) of an investigation that demonstrated selective absorption of silicone oil by a functionalized melamine sponge with a density of 8 mg/cm³ (M8).

FIG. 7 represents a nonlimiting process for separation of an oil using a functionalized melamine sponge with a density of 8 mg/cm³ (M8).

FIG. 8 is a schematic representation of an apparatus for separation of immiscible liquids, such as oil and water.

### DETAILED DESCRIPTION OF THE INVENTION

The present invention generally provides methods, apparatuses, and materials capable of separating immiscible liquids that are present in what will be referred to as an immiscible liquid mixture (which may contain constituents in addition to the immiscible liquids). As used herein, immiscible refers to two substances of the same phase or state that cannot be uniformly mixed or blended, or are substantially insoluble in each other, whereas miscible liquids are substances that can completely or partially uniformly mixed or blended. In particular, the methods, apparatuses, and materials herein are capable of removing a first liquid from a second liquid using a material having an affinity to the first liquid but repels or has an aversion to the second liquid. The methods, apparatuses, and materials may be particularly suitable for decontaminating bodies of water by removing one or more liquids that are immiscible in water, for example, removing oils and/or organic solvents therefrom. Although certain embodiments of the invention will be described hereinafter in reference to removing from water certain liquids that are immiscible in water, for example, animal or vegetable oils, certain organic solvents, and liquids that are obtained or derived from petroleum such as oil, gasoline, hexane, toluene, octadecene, and motor oil, it will be appreciated that the teachings of the invention are more generally applicable to other types and combinations of immiscible liquids present within a variety of immiscible liquid mixtures.

The aforementioned material for use in separating immiscible liquids may be a host material which is functionalized using a functionalizing agent that imparts properties to (functionalizes) the host material, including the ability to repel the second liquid (from which the first liquid is to be removed), despite the host material's initially wetting properties. Preferably, the host material is a relatively high porosity material that is capable of absorbing the first liquid. During use, the functionalized host material may be exposed to or immersed into the immiscible liquid mixture, wherein the first liquid, but not the second liquid, is absorbed by the functionalized host material. The absorbed quantity of the first liquid may be removed from the host material and collected. For example, the first liquid may be removed from the host material by applying negative pressure to the host material by way of, for example, a vacuum pump, and providing a passage for such removal. The functionalized host material, from which the first liquid has been removed, is preferably capable of being re-used to absorb more of the first liquid from the immiscible liquid mixture. Preferably, the functionalized host materials do not include nano-structured materials (such as CNTs, graphene, SiO₂, or Fe₃O₄), and are manufactured without chemical etching, polymer grafting, or any processes that involve a separate adhesive medium for binding the functionalizing agent to the host material.

In general, a higher porosity host material provides better performance in terms of an absorption capacity as a result of there being a larger amount of space within the host material to hold the first liquid. If the host material has relatively low porosity, it may still be functional for separating the immiscible liquids, but will likely not be as effective as a high porosity material. Various porous materials are suitable for use as the host material. Although examples of the host material herein are primarily sponges, such structure is not required. Non-sponge materials are foreseeable, particularly if they provide a combination of high porosity, low density, and relatively small pore size, all properties that promote an ability to absorb a liquid. In addition, the specific shapes and sizes of the pores in the host material also contribute to its dynamic absorption behavior. For example, if the host material is an extremely porous material, but has overly large pores, it may not be functional for separating the immiscible liquids. In particular, an overly large pore size may reduce the host material's ability to generate sufficient capillary pressure to draw the first liquid into the pores of the structure, and thereby negate the effectiveness of extraction from the second liquid. Based on investigations discussed below, it is believed that a particularly suitable pore size range for the host material is about 1 μm to about 150 μm and a particularly suitable porosity is 99 percent or more.

Nonlimiting examples of host materials include polymer sponges formed of materials such as but not limited to melamine, polyether, or polyurethane; metal foams such as but not limited to copper or nickle foams; and artificially-made 3-D porous materials with micro- or nano-structures thereon, such as carbon aerogels, carbon-nanofiber aerogels, graphene aerogels, and carbon nanotube (CNT) sponges.

Nonlimiting examples of functionalizing agents include polydimethylsiloxane (PDMS), polytetrafluoroethylene (PTFE), and fluorosilanes such as but not limited to 1H,1H,2H,2H-perfluorooctyltrichlorosilane, 1H,1H,2H,2H-perfluorooctyltriethoxysilane, and 1H,1H,2H,2H-perfluorodecyltriethoxysilane (PFOS), as these agents either comprise methyl (CH₃) groups or difluoromethylene (CF₂) groups, making them similar to oils in that they are non-polar and therefore repel polar molecules such as water. Such functionalizing agents can be applied as a coating on a host material that is initially superoleophilic to impart hydrophobic or superhydrophobic properties so that the host material may be used for separating an oil-water mixture into oil and water. In particular, the coating may define a functionalized surface on the host material that is superhydrophobic, and is preferably present on all surfaces of the host material, including the external surfaces of the host material and the internal surfaces within the porosities of the host material.

Preferably, the coating self-adheres to the host material without forming any chemical bonding or reactions with the host material. For example, the above-noted exemplary functionalizing agents are capable of coating polymer sponges, metal foams, and various artificially-made 3-D porous materials with micro- or nano-structures thereon without an additional adhesive or forming any chemical bonds with the host material. Though PDMS has previously been used as a binder material for attachment of nano-structured materials (such as nanofibers) onto sponge structures, PDMS itself was not previously recognized as having a functionalizing capability to create a robust, superhydrophobic material as a standalone coating, and therefore had not been previously used to form the surfaces of a host material that exhibit hydrophobic or superhydrophobic properties.

Notably, in previous applications wherein PDMS was used as a binder material for attachment of nano-structured materials to sponge materials (for example, polyurethane sponges), the average pore size and ligament size of those sponge materials were ostensibly much larger than the sponges favored by the present invention. For example, Wang et al., “Robust Superhydrophobic/Superoleophilic Sponge for Effective Continuous Absorption and Expulsion of Oil Pollutants from Water,” ACS Appl. Mater. Interfaces 2013, 5, 8861-8864, discloses polyurethane sponges that employ PDMS as a binder. Based on image scale bars, the sponges reported in Wang et al. have been estimated to have pore sizes of about 750 to 950 μm and ligament diameters of about 85 μm. The superhydrophobic property of a sponge is determined by the fraction of contact area between a droplet and sponge surface. Therefore, porosity based on a combination of pore size and sponge ligament diameter may be used to predict the hydrophobic property of PDMS-functionalized sponges, and as indicated by the investigations discussed hereinafter, a porosity of 99 percent or greater was required to produce a superhydrophobic surface on functionalized host materials. While not intending to promote any particular interpretation, based on the estimated pore size and ligament diameters disclosed in Wang et al., it appears that the sponge materials had porosities of less than 99 percent and therefore would not have been rendered superhydrophobic when coated with PDMS (no nano-structures).

According to a first nonlimiting embodiment, the host material is a melamine or polyether sponge and the functionalizing agent is PDMS. Investigations leading to the present invention showed that a melamine or polyether sponge functionalized with PDMS can exhibit superhydrophobic and superoleophilic wetting properties and is capable of separating oil from water. Melamine and polyether sponges are desirable host materials due to their ultra-low density, high porosity, and excellent elasticity, all of which promote improved absorption capacity. PDMS is a desirable coating material (functionalizing agent) due to its hydrophobic nature, mechanical flexibility, and stable chemical properties, and because it can be irreversibly bound to polymer sponge materials without the use of adhesives. Furthermore, PDMS-functionalized melamine and polyether sponges exhibit high recyclability in that they are capable of being repeatedly used for absorbing and collecting oil from water.

PDMS functionalized polymer sponges may be formed by various processes, a nonlimiting example being a solution-immersion process. The process includes submerging a sponge into a PDMS-hexane solution (for example, 5.5 g of PDMS per 150 mL of hexane) at room temperature for about one hour, followed by drying the sponge such that the PDMS is cured to form a PDMS coating that is preferably present on all surfaces of the sponge contacted by the solution, including external surfaces of the sponge and internal surfaces within the porosity of the sponge. The time and temperature required for drying the sponge may vary. For example, the sponge may be dried at 170° C. for four hours, or alternatively, the sponge may be dried for about 24 hours at room temperature. The drying temperature may be increased (restricted by the sponge melting point) in order to lower the drying time.

Hexane can be used to dissolve PDMS to yield a low-surface-tension PDMS material that can uniformly coat the sponge during the solution-immersion process. Other organic chemicals in which PDMS is soluble can be used in place of hexane, including but not limited to, cyclohexane, toluene, chloroform, heptane, and tetrahydropfuran.

The PDMS coating applied by a solution-immersion process imparts superhydrophobic properties to the polymer sponge. The wetting properties, absorption capacities, and oil-water separation efficiencies of the functionalized sponge are described hereinafter through investigations leading to the present invention. It was demonstrated that PDMS-functionalized polymer sponges can absorb various liquids with high selectivity, high absorption capacity, and good absorption recyclability.

Nonlimiting embodiments of the invention will now be described in reference to experimental investigations leading up to the invention.

In the investigations, melamine sponges with densities of 8 and 9.6 mg/cm³ and polyether sponges with densities of 14, 19, 23, and 26 mg/cm³ were obtained. These test sponges are designated herein as M8, M9.6, P14, P19, P23, and P26, and these designations are used throughout the following discussion to identify test sponges that were essentially identical in terms of material, density, and porosity. In this notation, M indicates that the test sponge was formed of melamine, P indicates that the test sponge was formed of polyether, and the number following the M or P indicates the density of the test sponge in mg/cm³. For example, M9.6 is used to identify melamine sponges with a density of 9.6 mg/cm³. It should be noted that in this disclosure the density numbers refer to the densities of the materials calculated from the total volume of a sponge, including the volume of the sponge attributable to the pores contained in the sponge, and therefore are also indicative of the relative porosities of the test sponges.

In order to functionalize the test sponges, a PDMS prepolymer (Sylgard 184A, 5 g) and a thermal curing agent (Sylgard 184B, 0.5 g) were added to hexane (150 mL). The hexane mixture was stirred for 40 minutes to form a homogeneous solution. The test sponges were cleaned with isopropanol and deionized water, and then dried in an oven at 100° C. for two hours. The clean dried sponges were then completely immersed in the hexane mixture for one hour, removed from the mixture, squeezed to remove excess absorbed solution, and then dried in an oven at 170° C. for four hours, yielding PDMS-functionalized sponges having PDMS coatings that were present on all surfaces of the sponges contacted by the solution, including the external surfaces of the sponges and the internal surfaces within the porosities of the sponges.

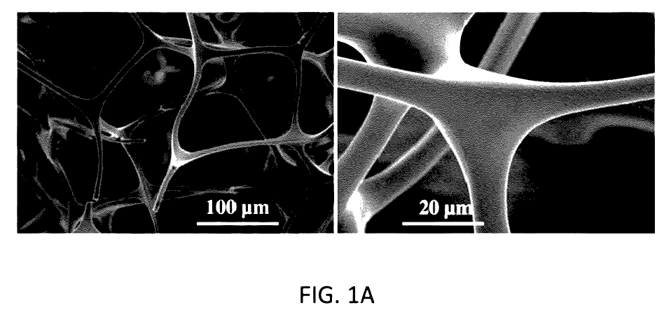

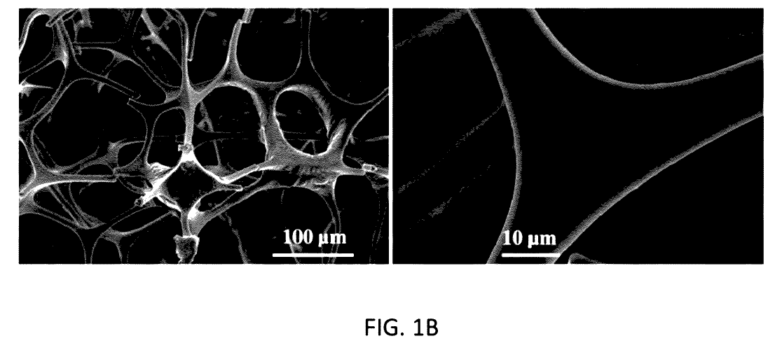

The surface morphologies of the PDMS-functionalized sponges were observed by scanning electron microscopy (SEM). FIGS. 1A and 1B show SEM images of the melamine sponges with bulk densities of 8 and 9.6 mg/cm³, respectively, and FIGS. 1C through IF show SEM images of the polyether sponges with bulk densities of 14, 19, 23, and 26 mg/cm³, respectively. As represented, the magnified sponge morphologies show that little or no roughness was formed on the sponge skeletons (structure) as a result of the coating, indicating that the sponges were conformally coated with a smooth film of PDMS, that is, the size of the angle between corresponding curved surfaces within the sponges remained unchanged. The pore sizes of the melamine sponges M8 and M9.6 were in the range of about 80 to 140 μm and about 50 to 100 μm, respectively, and cross-sections of the sponge ligaments were about 6 μm in diameter. The pore and ligament dimensions of the polyether sponges P14, P19, P23, and P26 were much larger, with pore size ranges of about 250 to 970 μm, about 230 to 900 μm, about 220 to 830 μm, and about 210 to 810 μm, respectively, and ligament cross-sectional diameters of about 56 μm, about 80 μm, about 85 μm, and about 96 μm, respectively. The smaller pore sizes and ligament diameters of the melamine sponges yielded a higher porosity level (greater than or equal to 99.4%) compared to the polyether sponges (about 97% to 98%).

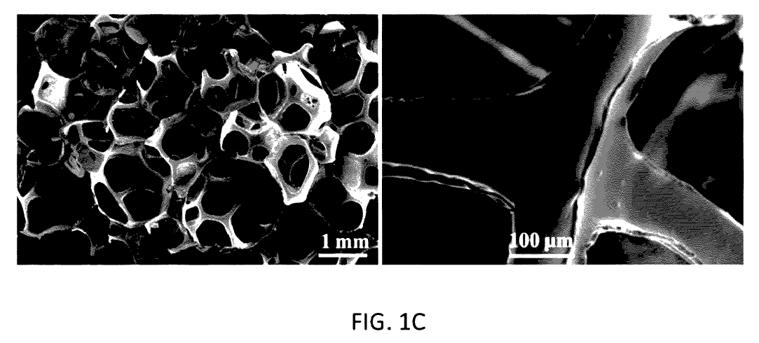

The elemental compositions of the surfaces of the sponges were determined by x-ray photoelectron spectroscopy (XPS). FIG. 2 represents XPS spectra for an unfunctionalized sponge, i.e., before being functionalized with a PDMS coating. The three peaks detected at 283 eV, 421 eV, and 531 eV were attributed to the bonding energies of C 1 s, N 1 s, and O 1 s, which are chemical components in melamine. After PDMS functionalization, the peak intensity associated with N is disappeared, and that of C is and O is were strengthened. In addition, two new peaks appeared at 101 eV and 152 eV which were attributed to Si 2 p and Si 2 s. The primary elemental components of PDMS include Si, C, and O; hence, the presence of Si peaks and the strengthened C and O peaks indicated that the sponge skeletons were successfully coated with PDMS. To evaluate the adhesion robustness of the PDMS coatings, the functionalized sponges were manually compressed flat and released for 200 cycles. As represented in FIG. 2, the peak intensities of the XPS spectra were unaltered, suggesting that the PDMS coatings remained strongly adhered to the sponges after completing the 200 compression cycles.

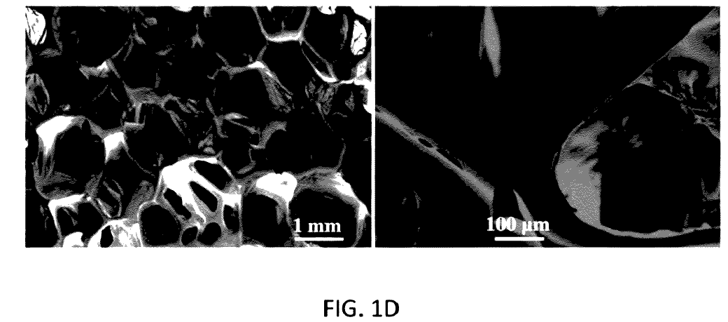

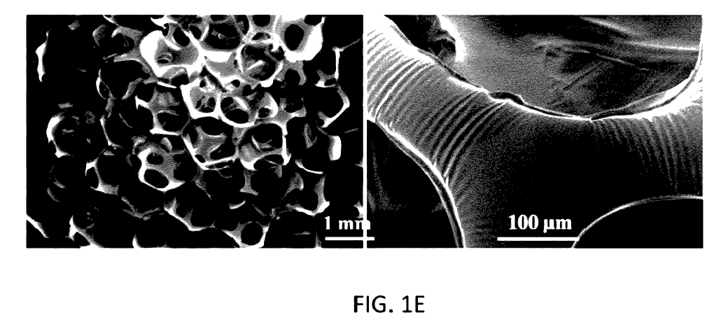

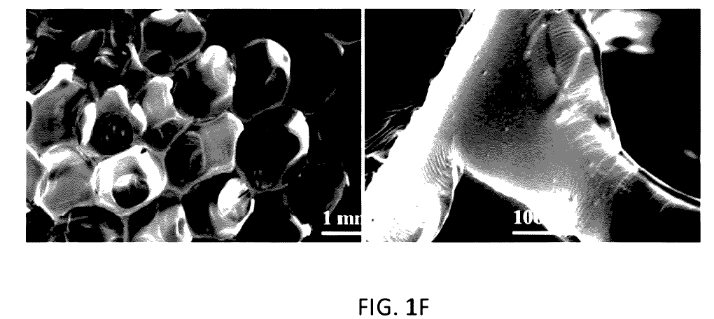

The surface wetting characteristics of the functionalized sponges were evaluated with sessile droplet experiments. Static water contact angles on the functionalized sponges were measured using a Ramé-Hart goniometer (Model 590). Droplets of about 5 μL were gently deposited on the samples with a pipette, and the contact angle was measured using the goniometer optics. The measurements were repeated three times at different locations on each sample, and the mean contact angle values were recorded. Liquids with different surface tensions (hexane, toluene, octadecene, silicone oil, and motor oil (5W-30)) were used as test liquids to demonstrate the superoleophilicity of the PDMS-coated sponges. FIGS. 3A through 3F show images of water and test liquid droplets placed on the test sponges M8, M9.6, P14, P19, P23, and P26, respectively. Each figure includes three images including (from left to right) a magnified contact angle image of water droplets (left), an image of water droplets and test liquid droplets (middle), and an image of the same surfaces after touching the water droplets with tissue paper (right). The dashed circles (in each of the FIGS. 3A through 3F; right) indicate the locations where the water droplets were initially deposited.

On the PDMS-coated melamine sponges (M8 and M9.6), water droplets sat atop the surface in a spherical shape. When touched with the tissue paper, the droplets were immediately absorbed by the paper and removed from the sponge surface without leaving any residual water, indicating negligible adhesion of water to these surfaces. Water droplets placed on the PDMS-coated polyether sponges (P14, P19, P23 and P26) appeared as slightly flattened spheres, and trace amounts of water were left after the water droplets were touched with tissue paper. The trends in wetting behavior for sponges with different densities are characterized by the water contact angle as shown in FIG. 3G, which shows water contact angles for each of the functionalized sponges studied. The contact angles on the higher-porosity melamine sponges M8 and M9.6 were larger than 150°, indicating their superhydrophobic nature. The water contact angle was decreased (but still hydrophobic) for the lower-porosity, higher-density polyether sponges, and on the order of about 135° or less.

As seen in FIG. 3H, the superhydrophobic nature of the PDMS-coated melamine sponges M8 and M9.6 was further indicated by the mirror-like sheen surfaces of the sponges that appeared when they were submerged in water. This appearance of the surfaces was attributed to a layer of air that was trapped between the water and the sponge. When test liquid droplets were placed on the PDMS-coated melamine and polyether sponges, they were immediately absorbed into the surfaces, indicating that the sponges had an effective contact angle of zero degrees and were superoleophilic (FIGS. 3A through 3F).

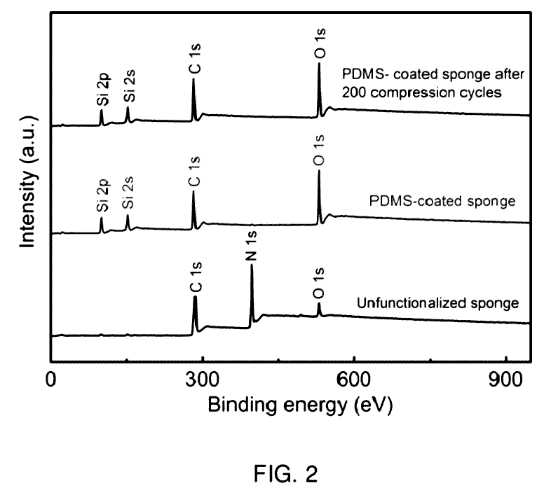

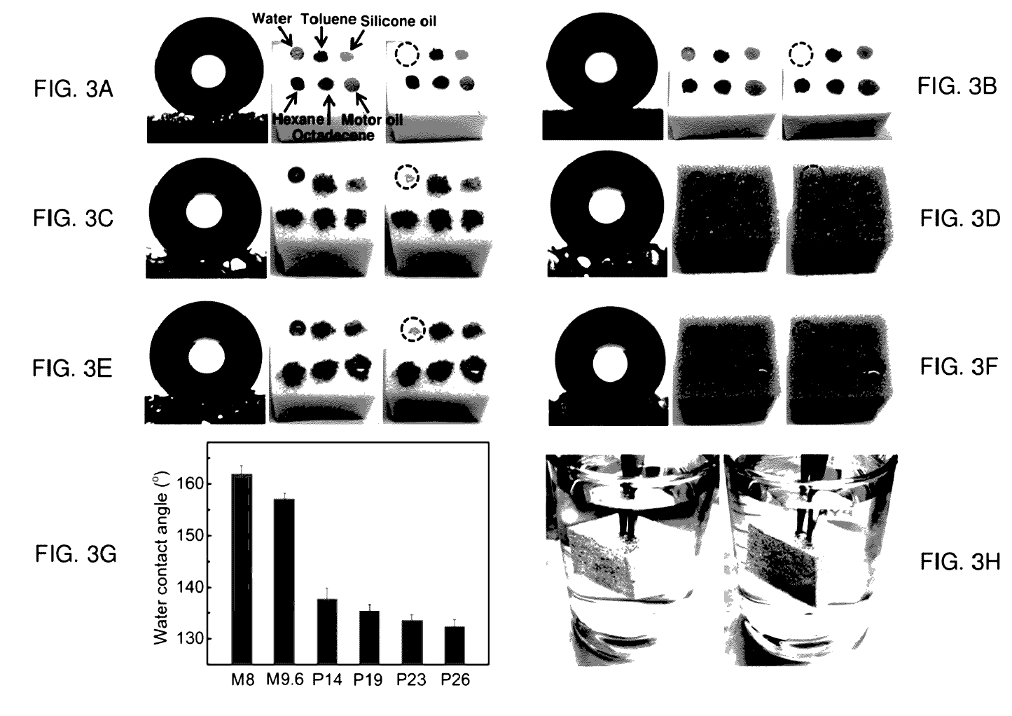

The degree of hydrophobicity of the PDMS-coated test sponges was further demonstrated by measuring the intrusion pressure (Pᵢₙₜ), which indicates the maximum water pressure that the sponge can support before it penetrates the surface. FIG. 4A schematically represents an apparatus of the type used to measure the maximum height (hₘₐₓ) of a water column that can be supported by a sponge interface. During testing, each test sponge 14 (about 2 cm thick) was clamped and compressed between two flanges 16 and water was gently poured into the top of a tube 12 until water penetration was visually observed at the surface of the sponge. The intrusion pressure Pᵢₙₜ is equal to pghₘₐₓ, where p is the density of water and g is the gravitational constant. FIG. 4B represents the measured intrusion pressures for the functionalized sponges with different densities. As represented, lower intrusion pressures corresponded to higher sponge densities, which in the test sponges were the result of lower porosities. This trend of intrusion pressure for the test sponges mirrored that of the static contact angle with water; that is, surface wettability (evidenced by low contact angles) increased with lower porosities. The wettability of surfaces is governed by both the surface roughness and the surface energy. All of the test sponges characterized herein were coated with the same low surface energy material (PDMS). Therefore, the superior hydrophobicity of the melamine sponges was attributed to their larger porosity (greater than 99.4%) compared with polyether sponges (about 97 to 98%), which results in a smaller fraction of solid-liquid contact area and lower water-droplet adhesion area, rendering the surface superhydrophobic (based on the Cassie equation).

Further investigations showed that the high porosity and superoleophilicity of the functionalized PDMS-coated test sponges allowed them to absorb a wide range of test liquids, including organic solvents and oils. The absorption capacity was determined by immersing the test sponges into pools of various test liquids until they were saturated with liquid. The weights of the saturated sponges were measured immediately after removal from the liquid pool to minimize the influence of evaporation of the organic solvents. The gravimetric absorption capacity (k) of the sponges was calculated as (m₁−m₀)/m₀, where m₀ is the weight of an unladen PDMS-coated sponge, and m₁ is the weight of the saturated PDMS-coated sponge. To assess absorption recyclability, the sponges were then manually squeezed out and immersed back into the test liquids until the sponges became saturated with the liquids again. This process was repeated 20 times.

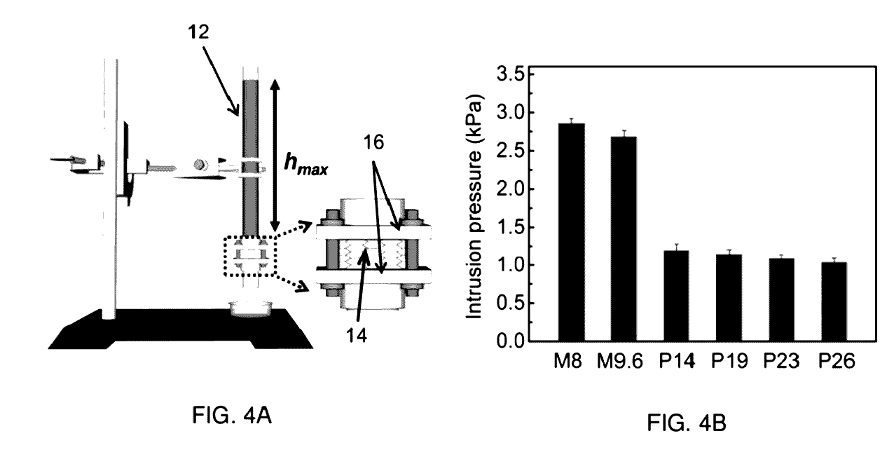

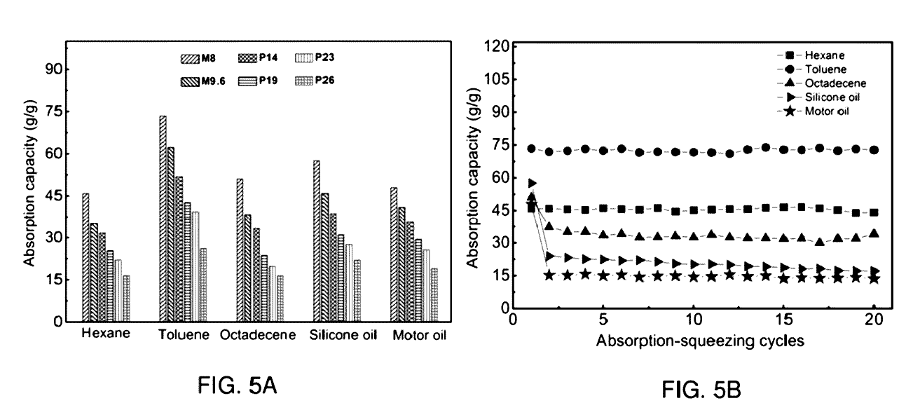

FIG. 5A shows the absorption capacity of the functionalized sponges for various test liquids, namely, hexane, toluene, octadecene, silicone oil, and motor oil. As represented, the absorption capacity decreased with higher sponge densities (lower sponge porosities). An M8 melamine sponge exhibited the highest absorption capacity, ranging from about 45 to 75 times its own weight, depending on the density of the particular test liquid. The high absorption capacity of the M8 sponge was directly ascribed to its high porosity, which provided the highest percentage open volume in the sponge for accommodating test liquids relative to the other test sponges.

For practical applications, sponges intended for separating immiscible liquids preferably should not only have high absorption capacities, but should also be reusable (i.e., absorption recyclability). The absorption recyclability of an M8 melamine sponge was evaluated via cyclic absorption-squeezing operations. As represented in FIG. 5B, for the organic solvents (hexane and toluene), the absorption capacity remained unchanged over 20 absorption-squeezing cycles. For the more viscous test liquids (octadecene, silicone oil, and motor oil), sharp decreases in the absorption capacity after the first cycle were attributed to residual test liquid that was retained in the open pore structures after squeezing the sponge. After the first cycle, the absorption capacity remained constant, indicating the reusability of the M8 sponge for the uptake of the test liquids.

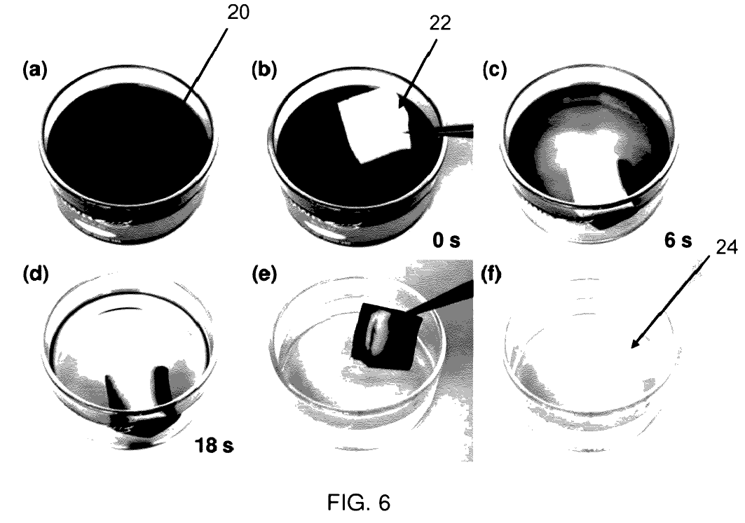

The simultaneous superhydrophobic and superoleophilic nature of the PDMS-functionalized sponges and particularly the melamine sponges is beneficial for selective separation of oil pollutants from water. FIG. 6 depicts six steps (a through f) that occurred during an investigation that demonstrated selective absorption of silicone oil by a functionalized M8 sponge. As represented, the silicone oil was used as an oil target 20 in water contained in a glass petri dish (image a). After partially immersing the sponge 22 into the immiscible oil-water mixture (image b), the oil layer was quickly absorbed by the sponge 22 within a few seconds (image c), after which the oil-laden sponge continued to float on the water surface (image d). After sweeping the sponge 22 over the surface to absorb all the oil (image e), oil-free water 24 remained in the glass petri dish (image f). This rapid separation demonstrated the potential of functionalized melamine sponges for oil pollutant cleanup and oil-water separation.

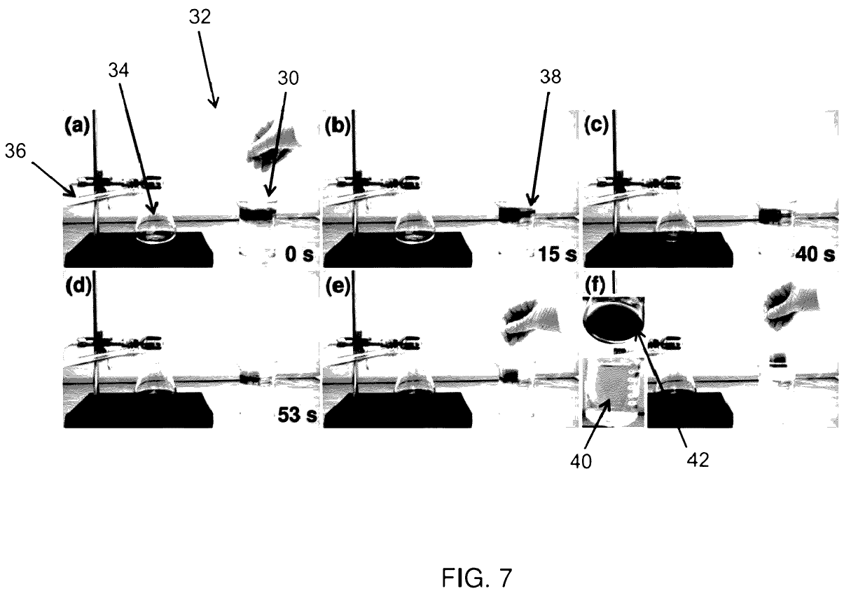

Due to the selective absorption behavior of a PDMS-functionalized sponge, a vacuum pump system was constructed to investigate the removal of oils from water in a continuous manner through the use of functionalized sponges. FIG. 7 shows the separation of a silicone oil-water mixture using an M8 melamine sponge (labeled 30). As represented, one end of a tube 32 was inserted into the core of the functionalized sponge 30 and the other end was attached to the top of a Buchner flask 34. The sponge 30 was partially immersed into the oil-water mixture 38 and immediately absorbed floating oils. A vacuum pump 36 attached to the flask 34 was activated and the absorbed oil flowed from the sponge 30, through the tube 32, and into the flask 34. For samples that did not have any visible water uptake, the moisture content of the collected oils was measured using a coulometer.

Referring to FIG. 7, when the sponge 30 was placed on the surface of the mixture 38, it was saturated with oil within about fifteen seconds. As the absorbed oil flowed through the tube 32 to the flask 34, oil in the vicinity of the sponge 30 was concurrently absorbed to achieve continuous separation of the oil from the water. The silicone oil was eventually completely removed from the water surface, leaving behind water 40 in the beaker. From qualitative observation, no uptake of water by the sponge 30 appeared in the flask 34 of oil (if water were extracted, it would have been clearly visible as immiscible water droplets in the flask 34). The experiment was repeated with both functionalized melamine sponges (M8 and M9.6) for four of the test liquids investigated (hexane, toluene, octadecene, and motor oil). Similar separation behavior was observed in each of the test liquids. The water content in each collected liquid 42 was measured and indicated that the purity of each collected sample was greater than 99.98% (the same purity as the unused water with no test liquids incorporated therein). These results indicated a nearly 100% separation efficiency, owing to the excellent selectivity of the functionalized melamine sponges.

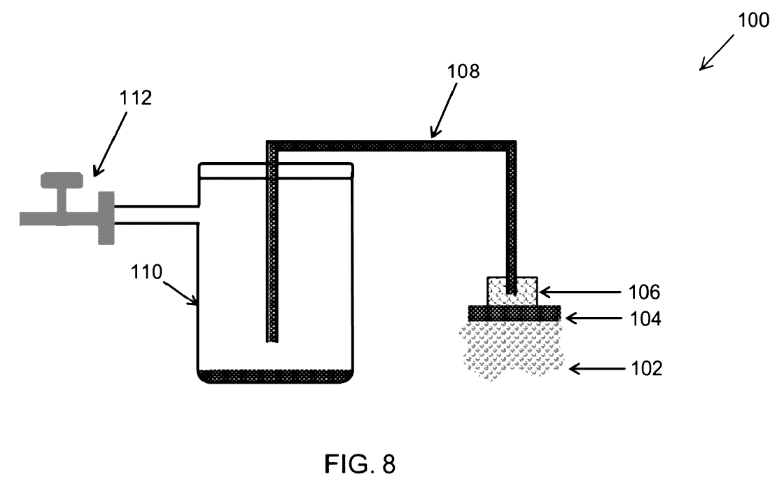

FIG. 8 schematically represents a nonlimiting embodiment of an apparatus 100 capable of efficient continuous separation of a liquid pollutant from a body of water. A body of contaminated water 102 is schematically represented along with an immiscible low-surface tension pollutant 104 on the water surface. A functionalized host material 106 (represented as a functionalized sponge) is depicted as partially immersed to a desired depth into the pollutant 104. The functionalized host material 106 is connected to a connecting tube 108 that is capable of drawing the pollutant 104 absorbed by the sponge 106 into a pollutant container 110 on which a vacuum pump 112 acts. It should be noted that instead of the vacuum pump 112, any method or device can be used if capable of drawing the pollutant 104 from the host material 106 into the container 110. As the absorbed pollutant 104 is removed, the functionalized host material 106 is again capable of removing the pollutant 104 from the surface of water 102, thus leading to a continuous operation. It is foreseeable that the pollutant container 110 can be configured to be emptied periodically or continuously as desired depending on the magnitude of the pollutant separation operation.

A variety of pollutant removal systems can be designed for efficient and continuous separation ofpollutants from water using functionalized host materials described herein. The systems may include an apparatus similar to that of FIG. 8 and can further include sensors capable of sensing the extent of separation of a pollutant and sensors capable of sensing if the pollutant container has reached a certain level and needs to be emptied. In some systems, an array of such functionalized host materials may be desired. In such an embodiment, sensors can be installed as part of the pollutant separation systems to monitor the functioning of each of the host materials and selectively replace them as needed. The systems may include various other components including but not limited to other types of sensors, components for computerized, automated operation, or wireless operation, etc. Software can be provided to control the operation of the apparatus described above and/or the systems described above.

In order to investigate the viability of using the above-described solution-immersion method to form a functionalized coating on other materials with fine porous structures, an additional investigation was performed where polyether fabric, cotton fabric, a cotton ball, and CuO nanowires were immersed into a PDMS-hexane solution for about one hour, removed, and then dried in an oven at about 100° C. (fabrics and cotton) or 170° C. (CuO nanowires) for about four hours. The fabrics and cotton were commercially available materials, whereas the CuO nanowires were prepared by chemically etching copper in an aqueous solution of 2 M NaOH and 0.1 M K₂S₂O₈ for thirty minutes. All of the test surfaces were intrinsically superhydrophilic before PDMS functionalization. Following functionalization, water droplets were placed on each of the PDMS-functionalized materials. The water droplets rested on the surfaces in a spherical shape and easily rolled off with slight tilting of the surfaces without leaving any traces of water, indicating the superhydrophobic nature of the modified materials. These results indicated that the solution-immersion method is capable of coating a variety of host materials with PDMS for imparting superhydrophobic properties thereto. Preferably, the solution-immersion method does not require the introduction of an additional adhesion medium to bind the functionalizing agent onto the host material, and does not use strong or corrosive etchants or other chemical agents that are environmentally unfriendly, that is, may inflict harm upon ecosystems or the environment, either during manufacturing of the materials or during use to separate immiscible liquids.

Examples of bodies of water in which the benefits of the invention may be utilized include, but are not limited to, water samples, ponds, lakes, oceans, wells, containers, etc. In a nonlimiting application, the concepts, methods, apparatuses, and systems of this disclosure can be used to remove pollutants from collected rain water. It can also be readily appreciated that the concepts, methods, apparatuses and systems can be very useful in addressing pollutant issues in large bodies of water, such as oil spills in oceans, lakes and rivers, fuel spills such as gasoline spills from ships, etc. In the case of an airplane crash in a body of water, the concepts, methods, apparatuses and systems disclosed herein can be used to remove aircraft fuel and other pollutants from the water.

While the invention has been described in terms of specific embodiments, it is apparent that other forms could be adopted by one skilled in the art. For example, the physical configuration of the host materials and apparatuses could differ from those shown, and materials and processes/methods other than those noted could be used. Therefore, the scope of the invention is to be limited only by the following claims.

1. A material comprising:
a porous host material capable of absorbing a liquid pollutant from water, the pollutant and water being immiscible, the host material comprising a polymer coating that defines a functionalized surface that renders the host material superhydrophobic.

2. The material of claim 1, wherein the pollutant is an oil or an organic solvent.

3. The material of claim 1, wherein the pollutant is selected from the group consisting of petroleum and petroleum-derived liquids.

4. The material of claim 1, wherein the host material is a sponge with a porosity of 99 percent or greater.

5. The material of claim 1, wherein the host material is a melamine or polyether sponge and the polymer coating comprises PDMS.

6. The material of claim 1, wherein the host material is superoleophilic.

7. The material of claim 1, wherein the host material does not include nanofibers.

8. A method of functionalizing the material of claim 1, the method comprising:
submerging the host material in a mixture comprising PDMS and a solvent such that the host material is coated with the PDMS; and
drying the host material with the PDMS thereon such that a conformal PDMS coating forms on surfaces of the host material.

9. An apparatus for removing a liquid pollutant from a body of water, the pollutant and water being immiscible, the apparatus comprising;
at least one functionalized host material comprising a host material which is capable of absorbing the pollutant, the at least one functionalized host material comprising a polymer coating thereon that defines a functionalized surface that is superhydrophobic; and
one or more connecting tubes configured to remove the absorbed pollutant from the at least one functionalized host material and transfer to a pollutant container functionally connected to a vacuum pump.

10. The apparatus of claim 9, wherein the pollutant is selected from the group consisting of petroleum and petroleum-derived liquids.

11. The apparatus of claim 9, wherein the at least one functionalized host material comprises a melamine or polyether sponge functionalized with PDMS.

12. The apparatus of claim 9, further comprising at least one additional functionalized host material which is superhydrophobic and is capable of absorbing the pollutant, and one or more connecting tubes configured to remove the absorbed pollutant from the at least one additional functionalized host material and transfer to the pollutant container functionally connected to the vacuum pump.

13. The apparatus of claim 9, further comprising a computer control for controlling absorption by movement of the functionalized host material and a sensing system to monitor the pollutant container and the vacuum pump.

14. The apparatus of claim 9, wherein the apparatus is configured for wireless control of operation for removing the pollutant from the body of water.

15. The apparatus of claim 9, wherein the functionalized host material is superoleophilic.

16. A method of removing a liquid pollutant from a body of water, the pollutant and water being immiscible, the method comprising:
bringing a functionalized host material to be in contact with a pollutant-water combination, wherein the functionalized host material absorbs the pollutant while repelling the water, the functionalized host material comprising a polymer coating thereon that defines a functionalized surface that is superhydrophobic.

17. The method of claim 16, further comprising continuously removing the absorbed pollutant from the functionalized host material.

18. The method of claim 16, wherein the functionalized host material comprises a sponge having a porosity of 99 percent or greater.

19. The method of claim 16, wherein the host material is a melamine or polyether sponge and the functionalizing agent is PDMS.

20. The method of claim 16, wherein the functionalized host material is superoleophilic.
